(19) United States
(12) Patent Application Publication
(10) Pub. No.: US 2009/0271036 A1
(43) Pub. Date: Oct. 29, 2009

(54) METHOD FOR INCREASING SAFETY WHEN OPERATING A ROBOT

(75) Inventors: Soenke Kock, Vaesteras (SE); Roland Krieger, Ladenburg (DE)

Correspondence Address: DARBY & DARBY P.C., P.O. BOX 770, Church Street Station, New York, NY, 10008-0770, US

(73) Assignee: ABB Patent GmbH, Ladenburg (DE)

(21) Appl. No.: 12/443,536

(22) PCT Filed: Sep. 4, 2007
(86) PCT No.: PCT/EP07/07685

§ 371 Date: Mar. 30, 2009

(30) Foreign Application Priority Data
Sep. 29, 2006 (DE) 10 2006 046 759.0

(51) Int. Cl. G06F 19/00

(52) U.S. Cl. 700/245

(57) ABSTRACT

A method for operating a robot with a tool changer comprises providing a plurality of different kinds of tools, associating each of the plurality of tools with an unique explicit signature, producing at least one safe signal using the tool changer, wherein the at least one safe signal is a two-channel signal corresponding to one of the unique explicit signatures, and identifying the at least one tool using the at least one safe signal.

This is a U.S. National Phase application under 35 U.S.C. § 371 of International Application No. PCT/EP2007/007685, filed on Sep. 4, 2007, which claims priority to German Application No. DE 10 2006 046 759.0, filed on Sep. 29, 2006. The International Application was published in German on Apr. 10, 2008 as WO 2008/040426.

### BACKGROUND

Industrial robots, which are used in automatic production in the automotive industry, for example, operate in such a manner, when fitted with various tools (grippers, spot/laser welding tongs, deburring tools, etc.), that they perform different tasks such as parts transport and handling, welding, joining etc. If a plurality of processes are intended to be performed by a single robot, this robot needs to be able to change its tool during the machining process. To this end, the robot is typically provided with a tool changer which allows tools to be picked up and deposited without manual intervention by an operator.

An application which requires the use of a tool changer can have the following appearance: A gripper fitted on the robot tip or on the robot head is used by the robot to grasp a workpiece in a workpiece holder and to move with the grasped workpiece to the machining station, where the workpiece is fixed. This involves the workpiece being placed onto the workpiece holder, generally by an operator, or involves the workpiece being directly placed onto the workpiece holder, generally by an operator, or being placed directly into the gripper of the robot. The gripper is then deposited in a gripper rack and the robot takes back a suitable tool for machining the workpiece from a tool holder, takes the gripper again and moves to the workpiece holder in order to put a new workpiece into the machining station. The finished workpiece can be removed from the workpiece holder by the robot or an operator and deposited in a workpiece store.

This means that the robot is provided with a tool changer and in so doing is used and operates in proximity to an operator. When a tool changer of this kind or various different tools is/are being used by an industrial robot, there is the risk that the operator operating in proximity to the robot will be injured, for example if the robot is carrying a welding gun instead of a gripper and takes it into the area which contains the loading station or workpiece holder.

The motions of a robot are prescribed by a program. Errors can occur if the program itself contains an error; it is also possible for the operator who starts the robot to make an error, for example by setting a program pointer to the wrong location and starting the robot, and there may also be an external PLC error, or the PLC program and the robot program do not operate in sync, particularly after a restart.

### SUMMARY OF THE INVENTION

It is therefore desirable to provide additional safety which prevents the robot from entering particular areas of the machining booth when an incorrect tool is detected, or from exiting a particular area of the booth when a dangerous tool is mounted on the robot.

An aspect of the invention is to provide a method for increasing safety when operating a robot, particularly an industrial robot, which achieves or at least increases the protection of an operator in a simple manner.

The invention thus involves the tool changer producing at least one safe, particularly two-channel, signal for identifying the fitted tool, each tool having an explicit signature associated with it and therefore different kinds of tools being able to be explicitly identified by means of the safe signal.

This signal may be electrical, magnetic, electrostatic; it may be a light signal or use radio waves or comprise other known means. Each signal signature has at least one associated virtual wall which is activated or deactivated when the signal is applied.

To further improve the protection of an operator, the virtual wall may be complemented or replaced by a virtual protective space or an axial region of the robot into which the robot is prevented from entering, particularly with an inadmissible or dangerous tool. In this case, the speed of motion particularly of the robot head is intended to be stopped or significantly reduced to a harmless speed of motion when the virtual wall or the virtual protective space is approached.

The invention prevents particularly the head of a robot which is carrying a dangerous tool, for example a welding gun, from being moved, particularly quickly and at high speed, into the area which may contain an operator, who could be injured by the robot. It is naturally possible for the robot head to enter the relevant area at very slow speed, so that the risk of injury no longer exists or is minimized. On the other hand, particularly when welding guns are being used, which can be at high temperature, entry into a protected zone must be prevented at all costs.

### BRIEF DESCRIPTION OF THE DRAWINGS

The invention and further advantageous refinements and improvements of the invention will be explained and described in more detail with reference to the drawings, which show a few exemplary embodiments of the invention and in which:

FIG. 1 shows a first embodiment of a robot booth with a virtual wall,

FIG. 2 shows a further embodiment of the robot booth with a protective area which has a rectangular shape,

FIG. 3 shows an arrangement similar to that in FIGS. 1 and 2 with a protective zone defined over an axial region,

FIG. 4 shows a further embodiment of a robot booth with a protective zone and what is known as a no-go zone,

FIG. 5 shows the schematic embodiment of tool identification,

FIG. 6 shows a schematic illustration of a refinement of a tool identification device,

FIG. 7 shows a schematic illustration of the robot/tool junction in the mounted state,

FIG. 8 shows a detail drawing of the junction shown in FIG. 7, to clarify an embodiment according to the invention,

FIG. 9 shows a perspective-photographic-illustration of a robot with a correct tool,

FIG. 10 shows the robot shown in FIG. 7 with an incorrect tool, in a similar illustration to that in FIG. 7, and

FIGS. 11 to 15 show different flowcharts which are intended to be used to explain the method according to the invention in more detail.

### DETAILED DESCRIPTION OF THE DRAWINGS

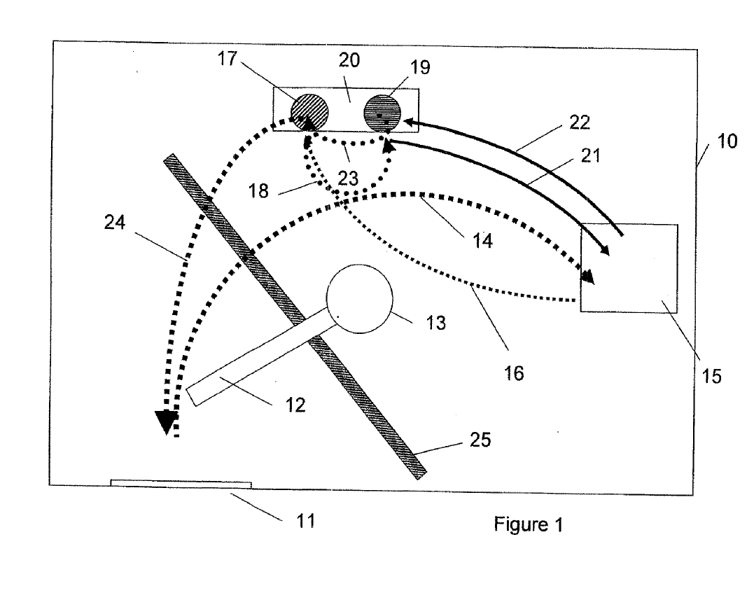

FIG. 1 shows a schematic illustration of a robot machining booth 10 with a manual loading station 11 on which tools are placed by an operator. Each of these workpieces is picked up by the arm 12 of an industrial robot 13 and supplied to a machining station 15 along a dotted line 14, which is chosen according to the space requirement. The head of the robot arm 12 contains a gripper in this case, which can be used to pick up the workpiece. Such grippers are known as such. It is possible for two-arm grippers or two-fingered grippers etc. to be used.

When the workpiece has been deposited in the machining station 15, the robot head or the robot arm with the gripper moves along the dotted line 16 to a gripper depositing station 17, deposits the gripper, moves along the likewise dotted line 18 to a tool holder 19 and picks up a new tool, the gripper holder 17 and the tool holder being in a common holding device 20. This holding device 20 is used for changing the tools. From the tool holder 19, the robot 12 with the relevant tool moves along the solid line 21 to the machining station 15 and, when machining of the workpiece has ended, moves via the line 22 back to the tool holder, deposits the tool there and moves along the line 23 to the gripper holder 17, takes a gripper and moves with it along the dotted line 24 to the loading station 11, where the robot 13 picks up a new workpiece and the machining operation is repeated anew as just described.

In the area of the loading station 11, which may contain an operator, the operator is at particular risk from the robot if the robot performs an incorrect motion and/or draws alongside the loading station 11 with a dangerous tool, such as a hot welding gun.

Accordingly, the robot 13 and the robot arm 12 have associated motion sensors or speed-of-motion sensors which measure the buckling motions of the robot arm 12 or the rotary motion of the robot 13 and convert them into signals which are supplied to a signal-processing and control device. The signals processed in this device are compared with suitable limit-value parameters. What is known as a virtual wall 25 can be penetrated by the robot only if the correct tool is fitted on the robot. The tool can move only on the trajectory marked by solid arrows. Moving along the dotted path 14, 24 through the virtual wall 25 results in the robot being switched off if it is carrying an inadmissible tool. In the illustration shown in FIG. 1, the area to the left of the virtual wall 25, which contains the loading station 11 and into which (see FIG. 1) the robot arm 12 projects, is protected.

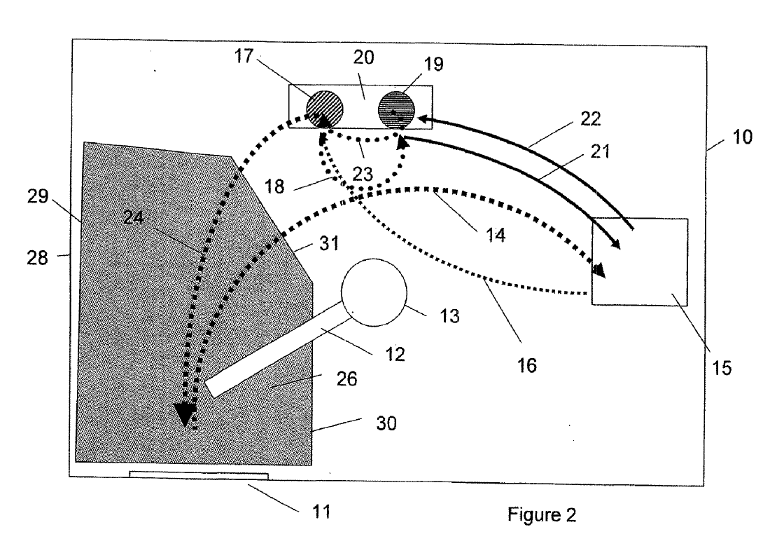

Reference will now be made to FIG. 2.

In the embodiment shown in FIG. 2, instead of a virtual wall 25, as shown in FIG. 1, what is known as a protective or prohibited zone 26 is provided, which in this case has an approximately rectangular shape, with one of the shorter sides 27 of the rectangle being situated close to the loading station 11. One of the longer lateral edges of the protective zone 26 is situated on the lateral wall 28 of the booth, said lateral wall being on the left in the figure, and bears the reference numeral 29 there. The lateral edge 30, which faces the robot 13 and runs at right angles to the lateral edge 27, has a bevel 31 in proximity to the holding device or gripper tool changing station 20 so that the robot or the robot arm can move as desired and also at suitable speed in the area there. The area outside of the prohibited zone is a permitted zone in which the robot can move freely.

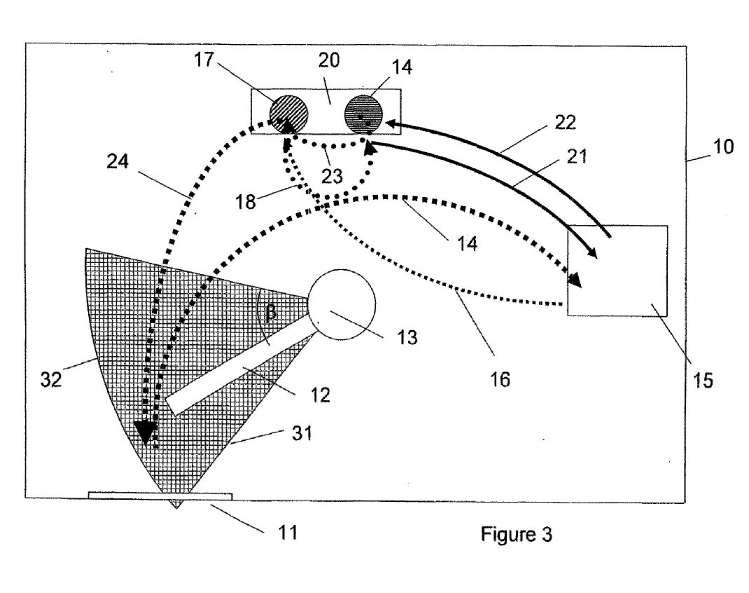

In the embodiment shown in FIG. 3, a protective zone 31 is formed which is a zone over an axial region of the robot whose center point is the center point of the rotary axis 1 of the robot. This axial region covers an angular range 2 and is proportioned such that the manual loading station and hence the operator are protected.

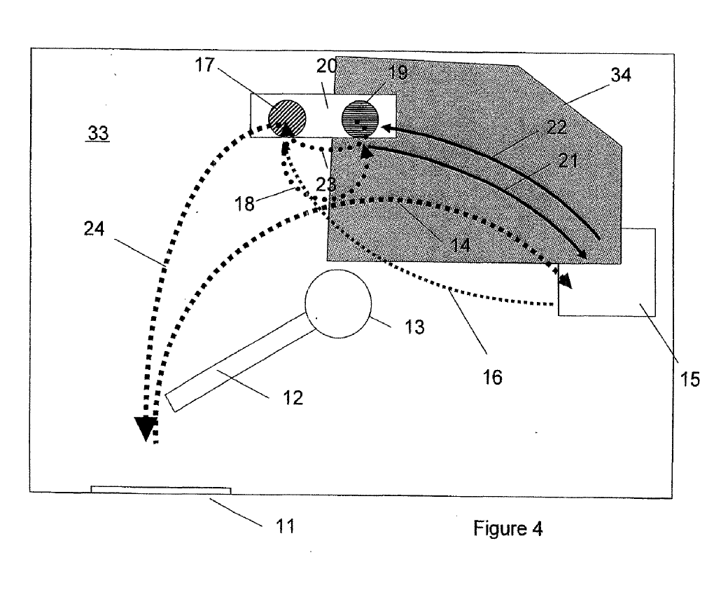

In the embodiment in FIG. 4, with otherwise the same arrangement of robot 13 and robot arm 12 and the same manner of movement along lines 14, 16, 18, 21, 22 and 23, a virtual protective zone 33 is formed in the area of the robot and a no-go zone 34 is formed in the areas of the trajectories 21 and 22. Exit from the no-go zone results in the robot being switched off, in the same way as entry into the zone 26 in the previous example. The no-go zone 34 is a area in which the robot can move along the lines 21, 22. If an inadmissible tool is fitted on the robot arm 12, the robot is not permitted to move outside of what is known as the permitted zone or no-go zone.

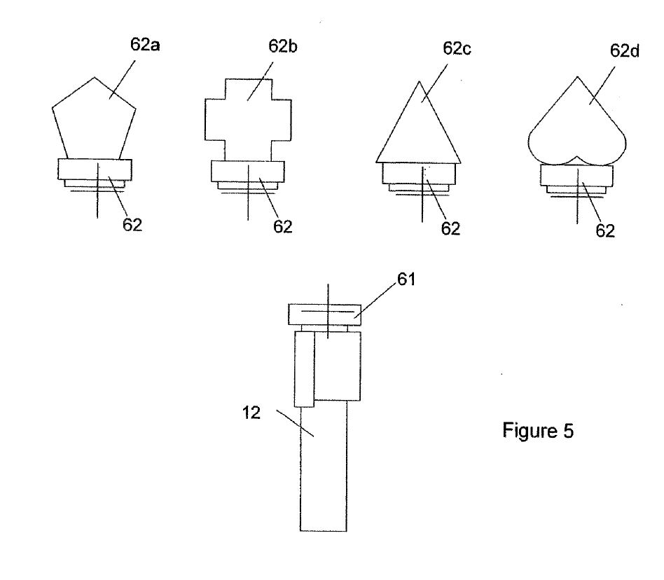

FIG. 5 shows a purely schematic illustration of a robot arm 12 on which a holding element 61 for holding a tool carrier 62 is fitted. This tool carrier can, as shown in FIG. 5, carry a plurality of tools in different forms, for example a tool 62a, 62b, 62c or 62d, which are fitteable on the holding element 61.

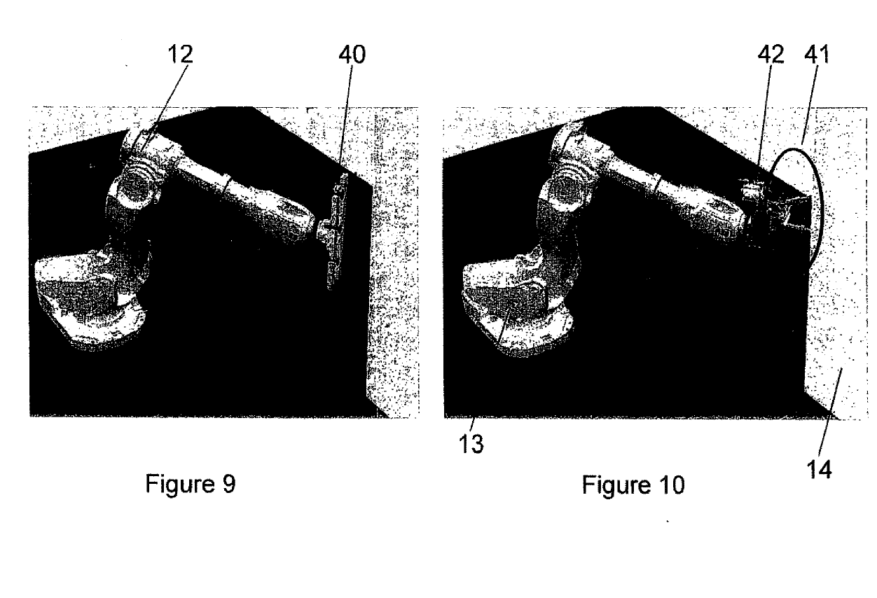

Reference will now be made to FIGS. 9 and 10.

FIG. 9 shows a robot 13 with its robot arm 12, the head of which has a correct tool 40 fitted on it (the type of tool is of no significance to the present invention) which, on the basis of the relevant motion and speed-of-motion signals, is at a suitable and correct distance from the virtual wall 14, for example, so that an operator situated behind the virtual wall is not put at risk. In this case, the tool 40 is in the form of a gripper, and as a gripper the tool 40 is apt to be able to enter the zone protected by the virtual wall 14.

The robot or the arm 12 of the robot (see FIG. 10) has an incorrect tool 42 on it, encircled by an elliptical line 41, which is apt to endanger (risk of injury) the operator; a tool which is a danger to the operator in this way must not penetrate the virtual wall 14 toward the operator.

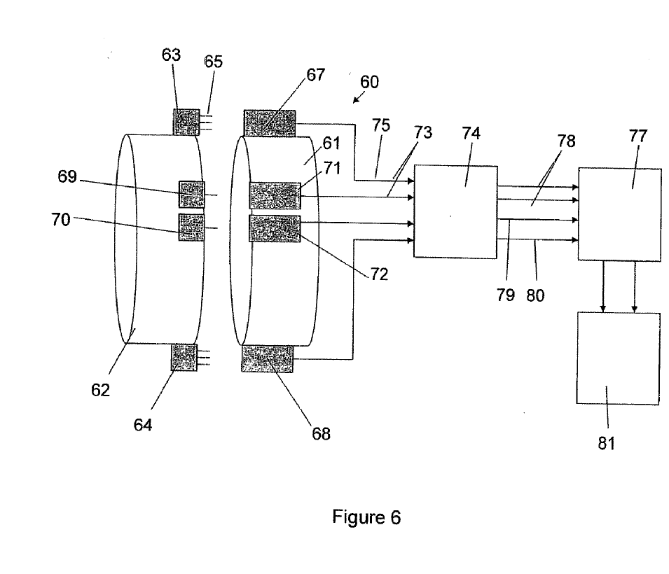

Reference will now be made to FIG. 6.

The robot head 60 of the arm 12, which is not shown in the figure, has a holding element 61 on it which is mounted on the robot head flange and on which a tool can be automatically connected or mounted. The mounting element 61 has a tool carrier 62 cooperating with it which has two elements 63 and 64 fitted on it which store a code associated with the tool. These elements 63, 64 have connecting contact pins 65 and 66 which, when the tool carrier 62 is connected, are inserted into suitable mating contacts on two code pickup elements 67 and 68 when the tool is brought against the operator control element 61. Furthermore, the tool carrier 62 also has two signaling elements 69 and 70 fitted on it which interact with corresponding holding elements 71 and 72 and supply a “tool connected” signal to a piece of decision logic 74 via a respective data line 73. The code pickup elements 67 and 68 are connected to the decision logic by means of further data lines 75 and 76, said decision logic supplying a control unit 77 with a “tool code confirmed” signal via data lines 78 on the control unit 77. Furthermore, the decision logic uses a line 79 to transmit an “OK” signal and uses a data line 80 to transmit an “error” signal to the control unit 77. This control unit actuates a robot protection device 81 which, if the tool code is incorrect and an “error” signal is supplied to the control unit 77, switches off the robot or significantly reduces the speed of motion to safe values.

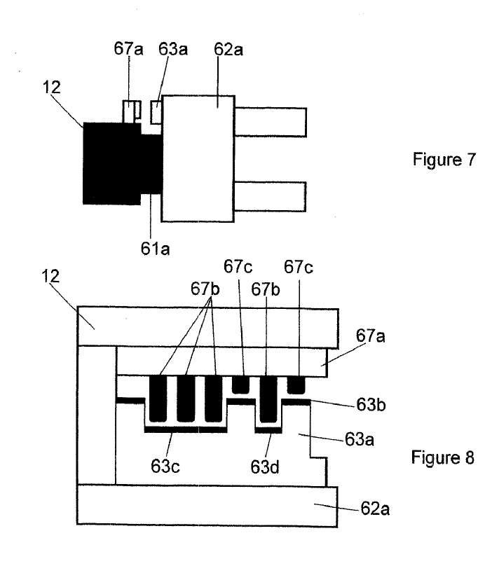

FIGS. 7 and 8 show one possible embodiment of a device which can be used to establish whether a correct tool is fitted on a robot. FIG. 7 shows a very schematic illustration of the robot arm 12 which has a flange 61A fitted on it, which indicates the mounting element 61 shown in FIG. 6. The robot arm 12 has a code pickup element 67A fitted on it, and the robot arm 12 has a tool 62A firmly connected to it which has a code carrier element 63A fitted on it.

FIG. 8 shows an exemplary embodiment of the arrangement shown in FIG. 7 in an enlarged, likewise schematic illustration. The robot arm 12 has a code pickup element 67A fitted on it which has a plurality of pins 67B and 67C of different length fitted on it. The tool 62A (or else tool carrier) has the code pickup element 63A fitted on it, which has two grooves of the same depth but of different width on a planar face 63B. The grooves 63C and 63D have pins 67B of relatively great length engaging in them, against which the shorter pins interact with the face 63B. If the intention is to pick up an incorrect tool, the code pickup element 63A is shaped differently, so that the pins cannot fit into corresponding grooves, as a result of which it is detected that the tool does not fit. Naturally, such an arrangement can also be tackled in another way, for example inductively or the like.

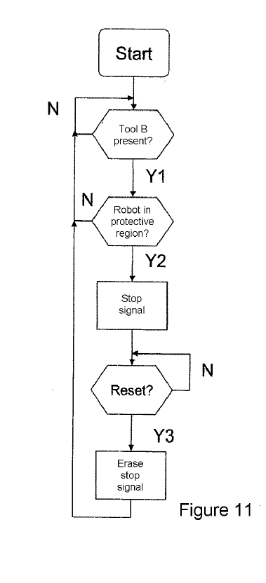

FIG. 11 shows a flowchart to explain the method. When the robot is started, a check is first of all performed to determine whether the tool B is present, for example; if it is not, the robot is restarted. If the tool B is now detected as being correct, as denoted by Y1, a check is performed to determine whether the robot is in the protected area or the prohibited zone. If so “Y₂”, a stop signal is produced; a reset is then performed, so that if the reset, that is to say the restart, is successful, the stop signal is canceled by means of the signal Y3.

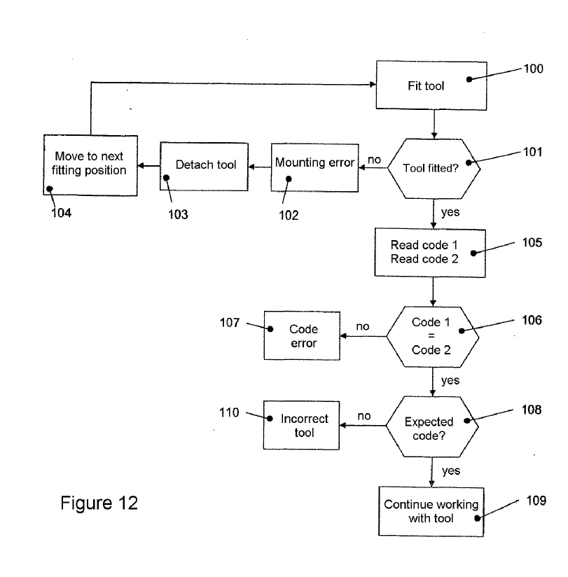

To identify whether the robot has a correct tool, a flowchart is shown in FIG. 12. In this case, a first step 100 involves a tool being fitted on a mounting element 61 using the tool carrier 62. A further method step 101 checks whether the tool is fitted correctly; if not, a “mounting error” signal 102 is produced which results in the tool 103 being removed, which moves the robot head to the next tool within the tool holder in accordance with 104.

If a correct tool is now in position, the two codes from the code carrier elements 63 and 64 are supplied to a code reader 105. The processing device 106 checks whether code 1 and code 2 are the same; if not, an “error signal” code 107 is produced which possibly leads back to the initial step 100 again. If the two codes are the same, a check is performed to determine whether the codes correspond to the expected codes, which is done in a processing device 108; if the code is the same as the expected code, the machining is continued with the tool in 109; otherwise, an “incorrect tool” signal is output, so that the process then starts again from the beginning.

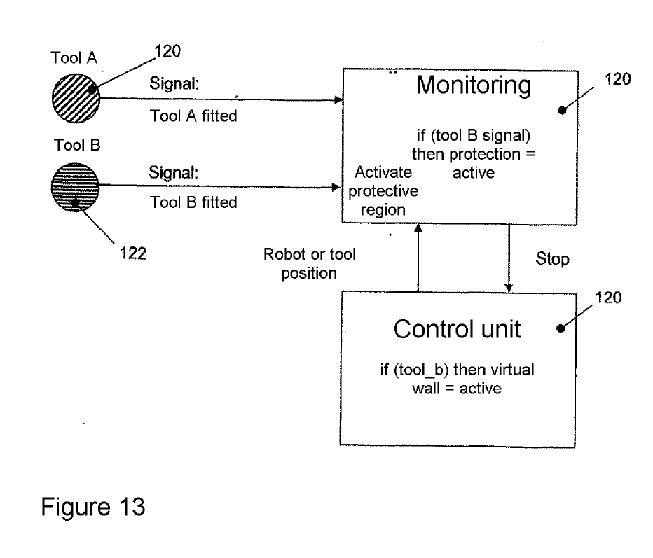

FIG. 13 schematically shows the mode of action or the sequence of the method when an incorrect tool is fitted. If the tool A is present, indicated by the shaded circle 120, a “tool A mounted” signal is sent to a monitoring device 121; if a tool B, indicated by the reference numeral 122, is mounted then a signal for activating a protective zone is sent to the monitoring unit 121; if the tool B is used and the virtual wall is active, the control unit 123 stops the robot when it approaches the virtual wall.

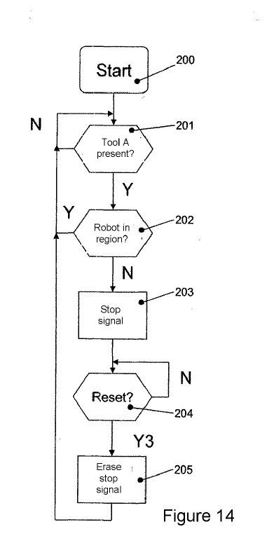

FIG. 14 shows a further flowchart for a further embodiment of a safety device according to the invention.

200 denotes the starting block, with which a robot is put into operation. In this case, it is first of all detected whether the tool A is provided, which is shown by the block 201. If so, 202 checks whether the robot is in the permitted zone, and if not then a stop signal 203 is produced; when a reset operation 204 has been performed, the stop signal is removed at 205 if the reset operation has been completed successfully. If the reset operation 204 has not been successful, it is repeated again.

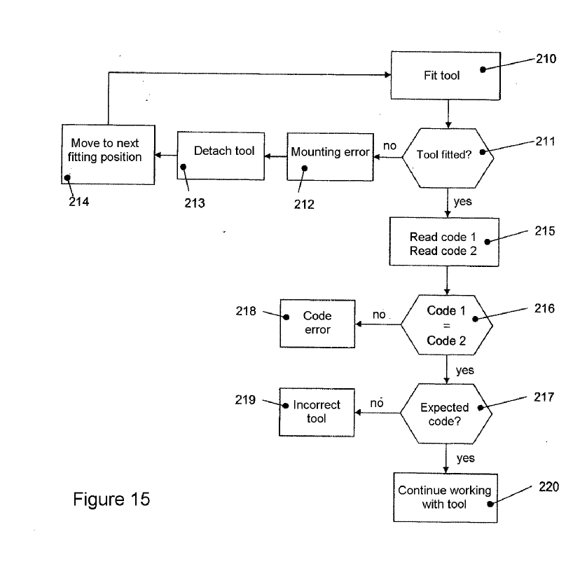

FIG. 15 shows a block diagram of tool identification. The robot moves to a tool holding station 210 at which a tool is mounted on the robot. At 211, a check is performed to determine whether the tool is connected, which can be done using the arrangements shown in FIG. 6, 7 or 8, for example. If not, an error signal 212 is produced, which prompts removal of the tool, block 213. At 214, the robot then moves to a further tool, which is mounted on the robot. The method sequence starts again at blocks 210 and 211. If the tool is present, both codes 1 and 2 of the elements 63, 67 and 64, 68 are checked and read which is done in 215. If code 1 is the same as code 2, the codes or signals from the two code elements 63/67; 64/68 are therefore the same, which is checked at 216, and then a check is performed in 217 to determine whether code 1 and code 2 are expected, that is to say are correct. If the two codes 1 and 2 are not the same, a code error signal 118 is produced, which results in a check by an operator control version; if the codes do not correspond to the expected codes, an incorrect tool signal is produced at 219, which then leads back to block 214, as a result of which the robot takes a new tool from the tool rack.

If the codes are the same and if the codes are expected, that is to say if the codes are correct, work continues with the tool in 220.

1-13. (canceled)

14: A method for operating a robot with a tool changer comprising:
providing a plurality of different kinds of tools;
associating each of the plurality of tools with an unique explicit signature;
producing at least one safe signal using the tool changer, wherein the at least one safe signal is a two-channel signal corresponding to one of the unique explicit signatures; and
identifying at least one tool using the at least one safe signal.

15: The method as recited in claim 14, wherein the method is performed with an operator in close contact with the robot.

16: The method as recited in claim 14, wherein each unique signature is associated with at least one virtual protective zone, and further comprising activating or deactivating the virtual protective zone when the at least one safe signal is produced.

17: The method as recited in claim 16, wherein the virtual protective zone includes at least one of a virtual wall and an axial region of a robot.

18: The method as recited in claim 17, further comprising influencing a motion of the robot relative to the virtual protective zone by defining robot entry into the virtual protective zone as prohibited, and defining robot exit from the protective zone as permitted.

19: The method as recited in claim 17, further comprising stopping or reducing a speed of motion of the robot when the robot approaches the virtual protective zone.

20: The method as recited in claim 14, further comprising measuring at least one of a motion and a speed of motion of the robot using at least one sensor, supplying a sensor signal from the at least one sensor to a control device, comparing the sensor signal with a limit-value parameter using the control device so as to produce at least one virtual wall, and preventing the robot from entering an area protected by the virtual wall at a high speed.

21: The method as recited in claim 20, wherein the virtual wall prevents the robot from passing through the virtual wall.

22: The method as recited in claim 16, further comprising associating at least two code carriers with the at least one tool for identifying the at least one tool, associating at least two code pickup units with the robot, comparing codes from the at least two code carriers using the at least two code pickup units, and stopping the robot if an error occurs.

23: The method as recited in claim 22, wherein the codes include at least one of electrical codes, optical codes, electromagnetic codes and barcodes.

24: The method as recited in claim 22, wherein the at least two code carriers are in programmable form.

25: The method as recited in claim 22, wherein each tool has an explicitly associated code.

26: The method as recited in claim 22, further comprising comparing the codes for at least one of validity and equality using a computation unit, and sending an inspection signal to a central controller, the signal being an enable signal or an incorrect tool signal.

27: The method as recited in claim 26, further comprising moving the robot into a tool-changing station so as to pick up a further tool if the signal is an incorrect tool signal, and repeating the step until a correct tool is found.

28: The method as recited in claim 22, further comprising transmitting safety signals to a machining unit or a central unit via bus systems.
